(19) United States
(12) Patent Application Publication
(10) Pub. No.: US 2005/0139425 A1
(43) Pub. Date: Jun. 30, 2005

(54) Ladder stabilizer

(76) Inventors: Merle Allan Thomas, Camden, DE (US); Brent Allan Thomas, Newark, DE (US); Shane Rodney Thomas, Newport News, VA (US)

Correspondence Address: RATNERPRESTIA, P.O. BOX 1596, WILMINGTON, DE, 19899, US

(21) Appl. No.: 11/002,376

(22) Filed: Dec. 2, 2004

Related U.S. Application Data
(60) Provisional application No. 60/527,139, filed on Dec. 4, 2003.

(51) Int. Cl. E06C 1/18

(52) U.S. Cl. 182/214

(57) ABSTRACT

An apparatus for mounting on an upper portion of a ladder to stabilize the ladder by facilitating a transfer of weight from the ladder to a horizontal or pitched surface in contact with the apparatus. The apparatus comprises a frame comprising a pair of connecting members for attaching to the upper portion of the ladder, a pair of extension arms secured to the frame and having a distance between them that is less than or equal to a distance between the stiles of the ladder, and a plate pivotably attached to both of the extension arms and having a flat surface. The extension arms have means for locking the arms in any one of a plurality of angles relative to a plane defined by the ladder.

### CROSS-REFERENCE TO RELATED APPLICATIONS

This application claims priority from U.S. Provisional Patent Application Ser. No. 60/527,139, filed Dec. 4, 2003, incorporated herein by reference.

### FIELD OF THE INVENTION

This invention relates to stabilization devices for ladders, specifically stabilization devices for attachment to an upper part of the ladder.

### BACKGROUND OF THE INVENTION

Extension ladders are well known in the art for leaning against houses, trees, and the like, for performing maintenance reaching areas above ground level. One common use for extension ladders is for facilitating climbing on the roof of a building, such as for example, a residential dwelling. Many injuries are caused each year because of people falling off of ladders due to instability of the ladder. A number of devices have been proposed for providing ladder stabilization, particularly for use with extension ladders when used for climbing on a roof. Many of these devices, however, are not versatile, while others are too complex.

One known device is disclosed in U.S. Pat. No. 5,165,501 to Donahey. The Donahey device is adapted to be installed on a ladder via a pair of adjustable-length threaded rods that are threaded through the hollow rungs of the ladder that extend between opposite rails (referred to as “stiles” throughout this application). Because this device attaches outside the stiles, it must be adjustable to accommodate different ladder designs, each of which may have different separation distances between stiles. The Donahey device also has several other adjustable features, resulting in an apparatus that is unnecessarily complex.

A number of other prior art devices are known for facilitating the use of extension ladders leaned against trees or buildings without extending all the way to the roof. For example, U.S. Design Pat. No. 406,652 to Marchand, incorporated herein by reference, discloses an adjustable ladder stabilizer known in the art for leaning a ladder against a building in the vicinity of a window, such that the stabilizer can be used to bridge a window to avoid the stiles of the ladder contacting the window, and generally can provide a desired standoff distance between the wall and the ladder. U.S. Pat. No. 6,691,825 to Haig, also incorporated herein by reference, discloses an apparatus for stabilizing a ladder when placed against, among other things, vertical surfaces that include an inside corner or an outside corner. U.S. Pat. No. 6,698,546 to Sandor, Sr. additionally incorporated by reference, discloses an apparatus for stabilizing a ladder when placed against a tree.

Despite the number of prior art ladder stabilizers, there is still a need in the art for a versatile, elegant design that is strong and relatively simple to use.

### SUMMARY OF THE INVENTION

One aspect of the invention comprises an apparatus for mounting on an upper portion of a ladder to stabilize the ladder by facilitating a transfer of weight from the ladder to a horizontal or pitched surface in contact with the apparatus. In one embodiment, the apparatus comprises a frame having at least two vertical members and two horizontal members attached to the vertical members, each horizontal member comprising a ledge for receiving a lower surface of a ladder rung. One or more securing members, such as U-bolts, secure the ladder rungs to the horizontal members. A pair of extension arms are pivotably connected to one of the vertical members and securable at one or more angles relative to the vertical member. A flat plate for contacting the horizontal or pitched surface is pivotably attached to the pair of extension arms. The extension arms are preferably securable in a plurality of angles relative to the vertical member, and in one embodiment the vertical members each comprise a brace portion having a plurality of apertures arranged in an arc, each aperture for receiving a member to secure the extension arm at a desired angle corresponding to the aperture. The frame may further comprise one or more attachments sized to be removably attached to the flat plate for providing stabilization for a use of the ladder other than with the flat plate in contact with a horizontal or pitched surface, such as for facilitating leaning the ladder against a tree, or for spanning a window when the ladder is leaned against a building.

Another aspect of the invention comprises an apparatus for mounting on an upper portion of a ladder to stabilize the ladder by facilitating a transfer of weight from the ladder to a horizontal or pitched surface in contact with the apparatus. The apparatus comprises a frame comprising a pair of connecting members for attaching to the upper portion of the ladder, a pair of extension arms secured to the frame and having a distance between them that is less than or equal to a distance between the stiles of the ladder, and a plate pivotably attached to both of the extension arms and having a flat surface. The extension arms have means for locking the arms in any one of a plurality of angles relative to a plane defined by the ladder.

In one embodiment, the connecting members comprise a pair of vertical members for attaching to vertical stiles of the ladder and the extension arms are connected to the vertical members by a lockable hinge.

In another embodiment, the connecting members comprise a pair of horizontal members attached to a pair of vertical members to form the frame, each horizontal member comprising a ledge for receiving a lower surface of a ladder rung, the extension arms pivotably connected to the vertical members. The vertical members each comprise a portion having a plurality of apertures arranged in an arc for locking the extension arms at any one of the plurality of angles, the apparatus further comprising one or more securing members for securing the ladder rungs to the horizontal members.

In yet another embodiment, the connecting members comprise a first horizontal member for securing to an upper rung and a diagonal brace member attached to the first horizontal member at one end and secured to a lower rung at the opposite end. The extension arms are pivotably connected to the first horizontal member and the first horizontal member comprises a portion having a plurality of apertures in an arc for locking the extension arms at any one of the plurality of angles.

In still another embodiment, the frame comprises at least two vertical members and two horizontal members attached to the vertical members, the connecting members comprising the horizontal members, each horizontal member adapted to be secured to a lower surface of a ladder rung. The frame further comprises a pair of brace members each pivotably connected to the vertical members each having a length with a plurality of apertures along the length. Each aperture positioned to be aligned with a mating aperture in each extension arm and pinned through the aligned apertures to lock the extension arms in any one of the plurality of angles.

In still another embodiment, the frame comprises a first horizontal member for contact with a lower surface of an upper ladder rung, and a second horizontal member for connection between a pair of risers. Each riser has a slot for receiving a lower ladder rung, the first and second horizontal members each attached to a first and second pair of threaded rods, respectively. The first pair of threaded rods is connected to the second pair of threaded rods by a pair of turnbarrels. The risers are each connected to one end of a lockable hinge, and the extension arms are attached to an opposite end of the lockable hinge.

In still another embodiment, the frame comprises a first horizontal member for pivotably attaching to an upper ladder rung, and a second horizontal member for pivotably attaching to a lower ladder rung. The extension arms are attached to the first horizontal member. A first threaded rod is secured to a pivot point attached to the extension arms and a second threaded rod is secured to the second horizontal member, the first and second threaded rods connected by a turnbarrel. The extension arms can be locked at any one of the plurality of angles by turning the turnbarrel to change a distance between ends of the first and second threaded rods.

The invention also comprises a ladder comprising any of the apparatus described above.

### BRIEF DESCRIPTION OF THE DRAWINGS

FIG. 1 depicts a perspective view of an exemplary ladder stabilizer embodiment of the present invention.

FIG. 2 depicts a front view of the stabilizer of FIG. 1.

FIG. 3A depicts a side view of another exemplary ladder stabilizer embodiment of the present invention featuring an articulated locking hinge.

FIG. 3B depicts a rear view of the embodiment of FIG. 3A.

FIG. 4A depicts a side view of another exemplary ladder stabilizer embodiment of the present invention.

FIG. 4B depicts a face view of a connecting portion of the embodiment of FIG. 4A.

FIG. 5A depicts a side view of another exemplary ladder stabilizer embodiment of the present invention.

FIG. 5B depicts a face view of the ladder stabilizer of FIG. 5A.

FIG. 5C depicts a top view of the pivot face plate of the stabilizer of FIG. 5A.

FIG. 6A depicts a side view of another exemplary ladder stabilizer embodiment of the present invention.

FIG. 6B depicts a face view of the ladder stabilizer of FIG. 6A.

FIG. 7A depicts a side view of another exemplary ladder stabilizer embodiment of the present invention.

FIG. 7B depicts a face view of the ladder stabilizer of FIG. 7A.

FIG. 8 depicts a top perspective view of a ladder stabilizer mounted on a ladder with an attachment for use against a tree.

FIG. 9 depicts a side perspective view of a ladder stabilizer mounted on a ladder with an attachment for use against a house

### DETAILED DESCRIPTION OF THE INVENTION

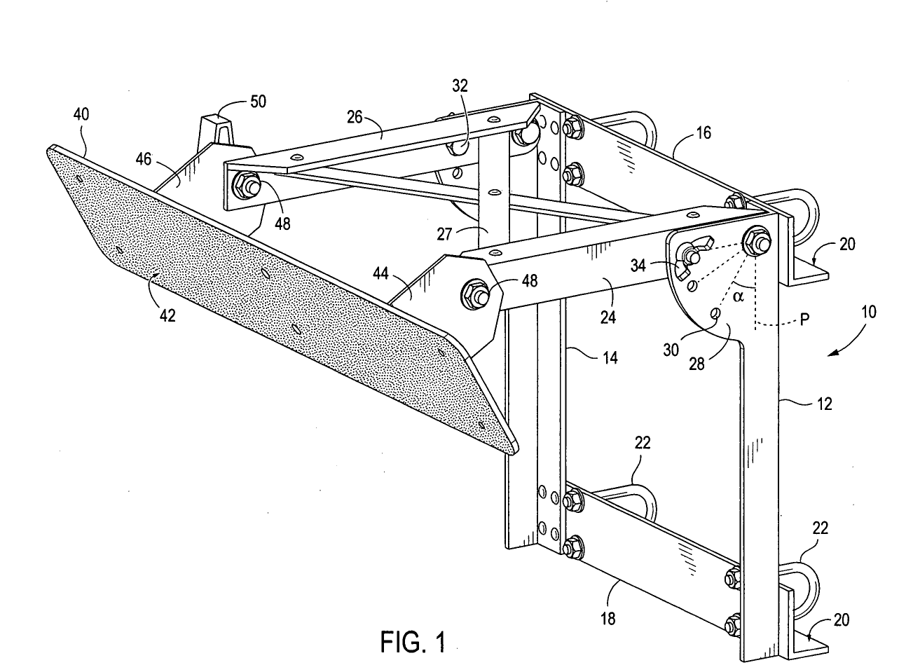

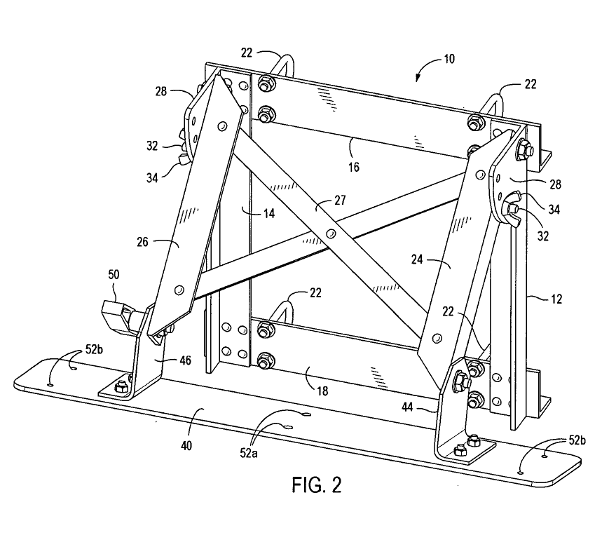

The invention will next be described with respect to the figures. FIGS. 1 and 2 show one embodiment of the present invention. Frame 10 comprises two vertical members 12 and 14 and two horizontal members 16 and 18 attached to the vertical members. A preferred material of construction is aluminum, but the frame may be any material known in the art, including other typical ladder materials such as fiberglass or wood. Each horizontal member 16, 18 has an L-shaped cross-section and comprises a ledge 20 for receiving a lower surface of a ladder rung (not shown). One or more securing members, such as U-bolts 22, are used for securing the ladder rungs to the horizontal members. A pair of extension arms 24 and 26 are each pivotably connected to one of the vertical members and securable in a plurality of angles relative to the vertical member. Bracing, such as cross-brace 27, may be provided between the extension arms.

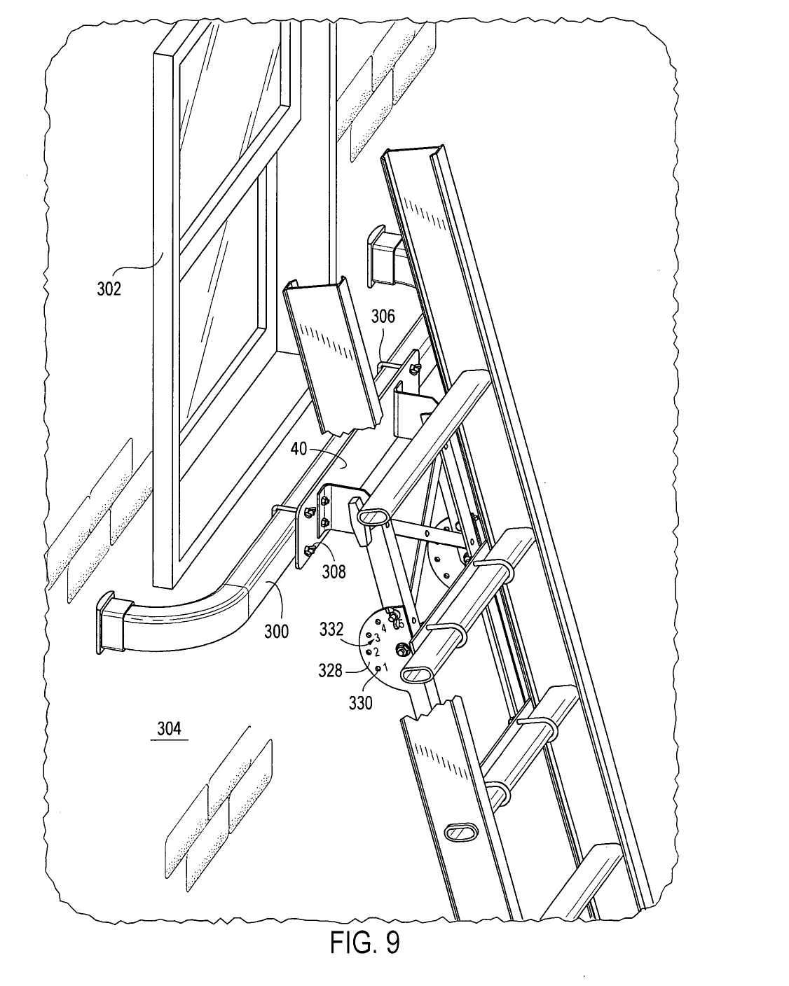

Each vertical member has a portion 28 having a plurality of apertures 30 arranged in an arc for receiving a member, such as a threaded bolt 32 secured with a wing nut 34, for securing the extension arms at the desired angle corresponding to the aperture. It should be understood that although the metal edge beyond the apertures is also arcuate as depicted in FIG. 1, the geometry of the edge is not critical. As shown in FIG. 1, the location of the apertures are set to result in the extension arms being positioned at one of three angles α approximately 45 degrees (lower hole), 90 degrees (upper hole), or 77.5 degrees (intermediate hole, as shown in FIG. 1) relative to the plane P of the ladder. Although portion 28 is shown in FIG. 1 in the shape of a quarter circle having only three apertures, portion 28 may extend less than or more than a quarter circle and may have more or fewer apertures. For example, in the exemplary embodiment shown in FIG. 9, portion 328 comprises a semi-circle with five apertures 330 arranged in an arc and provided with indicia 332 (numerals 1-5) labeling each aperture.

Plate 40 has a flat surface 42, preferably provided with a slip-resistant surface such as rubber or a rubber-like material, for contacting the roof (not shown) and is pivotably attached to the pair of extension arms via brackets 44 and 46. The pivotable attachment between plate 40 and the extension arms may comprise, for example, a pair of nuts/bolt combinations 48, with one of the bolts comprising a mechanism for increasing or decreasing resistance to an applied pivot force, such as a T-shaped handle 50. Plate 40 may comprise one or more features, such as apertures 52a and 52b, that can be used for receiving one or more removable attachable members or may be used for securing the flat plate to the roof, such as with nails.

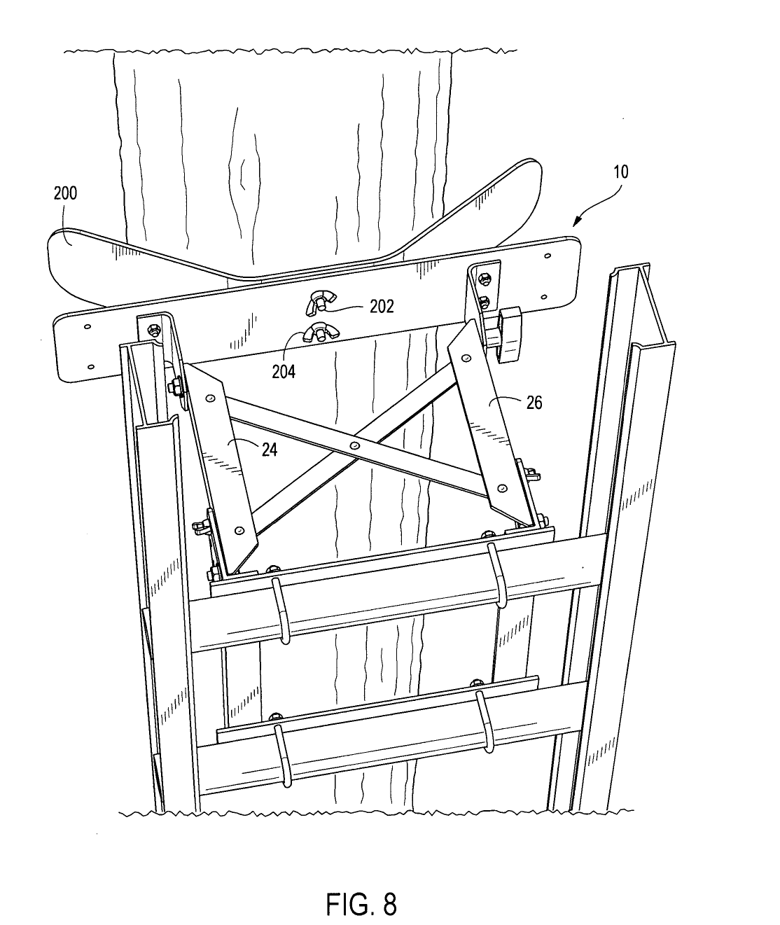

The one or more attachable members may be provided with mating apertures and otherwise sized to be removably attached to the flat plate for providing stabilization for uses of the ladder other than with the flat plate in contact with a roof. For example, the removably attachable member may comprise a member for facilitating leaning the ladder against a tree, such as is shown in FIG. 8. As shown in FIG. 8, attachment 200, attached to frame 10 with bolts 202 placed through apertures 52a (shown in FIG. 2) and secured with wing nuts 204, comprises a U-shaped member for receiving the tree trunk. Extension arms 24 and 26, particularly when set at a 90 degree angle to the ladder, provide for the ladder to be extended substantially from the tree. This allows the ladder user to stand at or near the top of the ladder and still be offset from the tree a comfortable working distance, as compared to right up against it as is shown, for example in the Sandor reference.

The removably attachable member is not limited to a tree adaptor, however, and may also or instead comprise an attachment 300, such as for spanning a window 302 when the ladder is leaned against a building 304 as shown in FIG. 9, similar to the design disclosed by Marchand. Attachment 300 is attached to plate 40 of frame 10 via U-bolts 306 placed through apertures 52b (shown in FIG. 2) and secured with wing nuts 308. Although shown with the extension arms locked in an uppermost position of portion 328 with the extension arms nearly parallel to the ladder to provide the stand-off as close to the top of the ladder as possible, the user may choose to use such an attachment with the extension arms locked into any one of the apertures 330. The attachment may also or instead comprise a member for leaning the ladder against an inside or outside corners (not shown), such as but not limited to that shown by the Haig. The present invention may be provided with a plurality of attachments for different purposes, or may be provided with one or more multi-purpose units, such as is shown and described in Haig, who shows a single unit that can also be adapted for spanning windows, leaning against trees, and leaning against inside or outside corners. The present invention may be sold with such attachments, or the attachments may be sold separately.

Similarly, the frame embodiments of the present invention may be sold with ladders, or separately. The present invention relates to both the frames themselves, and ladders on which such frames are mounted. Preferably, frame 10 is adapted to be attached to any extension ladder known in the art by virtue of the vertical members 12 and 14 being spaced apart a distance that is shorter than the distance between the stiles of any ladders known in the art. By providing a design that attaches to the ladder rungs between the stiles, rather than through the hollow rungs as is shown in Donahey, frame 10 can have a fixed, non-adjustable distance between the vertical members rather than being width-adjustable, which would add cost and complexity.

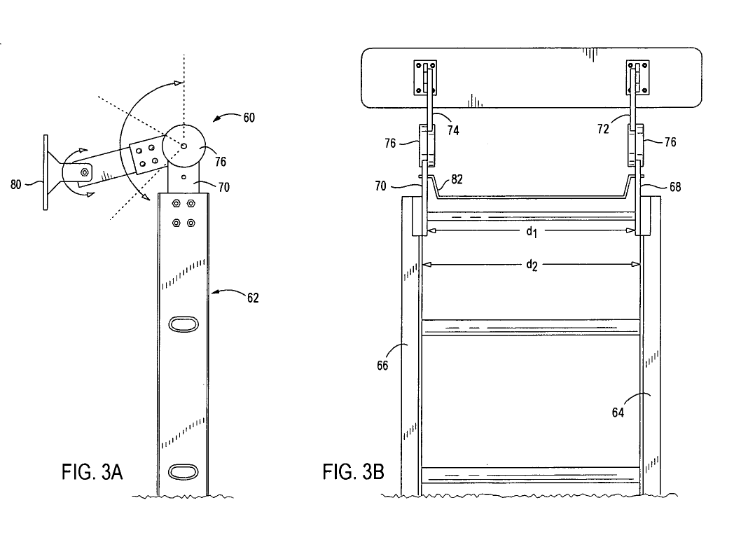

Although FIGS. 1 and 2 show a particularly simple and elegant design, there are a number of designs that can provide similar advantages. For example, FIGS. 3A and 3B depict a frame 60 that attaches to a ladder 62 (such as with bolts and mating nuts) on the top inside of the stiles 64 and 66 via a pair of connecting members, such as vertical members 68, 70. Extension arms 72, 74 are attached to articulated locking hinges 76 for locking the arms in any one of a plurality of angles relative to a plane defined by the ladder. Here, as in FIG. 1, the extension arms are separated by a distance d1 that is less than or equal to the distance d2 between the stiles. Plate 80 (which may be identical to plate 40) is pivotably attached to both of the extension arms. The articulated locking hinges may be any type of hinge known in the art, such as hinges manufactured by Climbtek of Ypsilanti, Mich., and may have a release lever 82, as is known in the art.

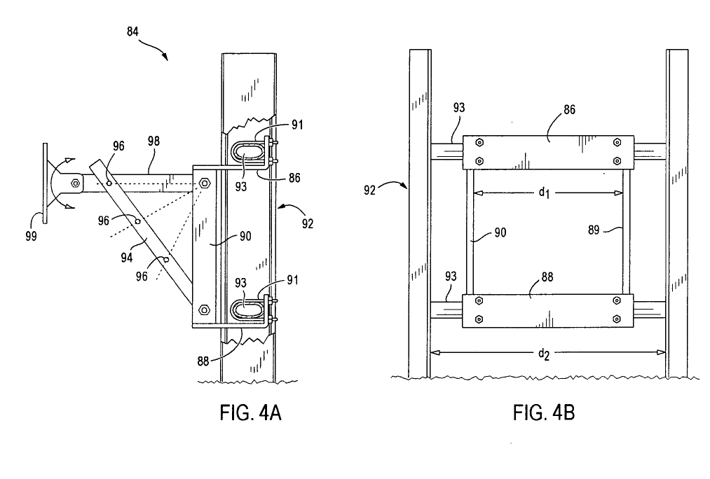

In another embodiment 84, shown in FIGS. 4A and 4B, the frame comprises at least two horizontal members 86, 88 attached to at least two vertical members 89, 90. Each horizontal member 86, 88 is adapted to be secured, such as with U-bolts 91, to the ladder 92 in contact with the lower surface of a ladder rung 93, similar to the design shown in FIGS. 1 and 2. FIG. 4B depicts only the horizontal and vertical members, to avoid clutter. As shown in FIG. 4A, the frame further comprising a pair of brace members 94 each pivotably connected to the vertical members and each having a length with a plurality of apertures 96 along the length, each aperture adapted to be pinned to a mating aperture in each extension arm 98 to lock the extension arms in any one of a desired plurality of angles. As in FIGS. 1-3, the extension arms are separated by a distance d1 that is less than distance d2 between the stiles. Plate 99 is similar to plate 40 described above.

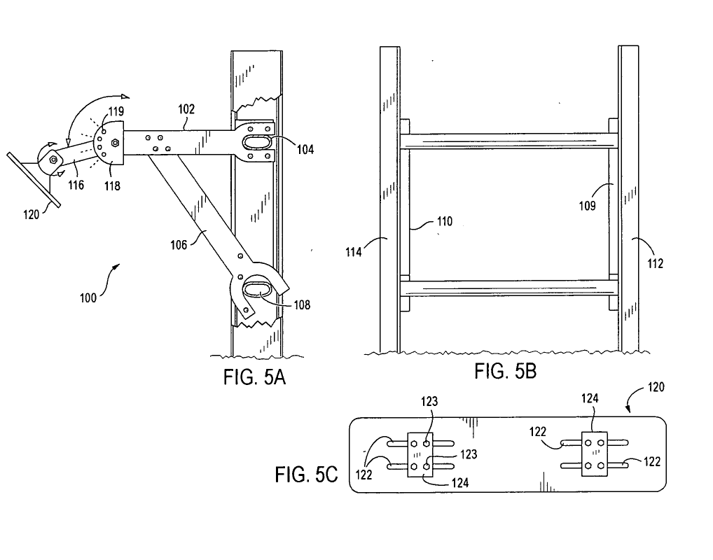

FIGS. 5A-5C depict yet another embodiment in which frame 100 generally comprises a horizontal member 102 for securing about an upper rung 104 and a diagonal member 106 for securing about a lower rung 108. The horizontal member 102 and diagonal member 106 are both mounted to vertical members 108 and 110 positioned inward of the ladder stiles 112 and 114, respectively. Extension arms 116 are pivotably connected to the first horizontal member via a locking member 118 having a plurality of apertures 119 arranged in an arc for locking the extension arms at any one of a plurality of angles, such as with bolts. Plate 120, shown in FIG. 5C is similar to plate 40 described above, except that it includes slots 122 for receiving bolts 123 attached through brackets 124, which allows the distance between vertical members 110 and 108 to be adjusted to fit ladders with different spacings between stiles.

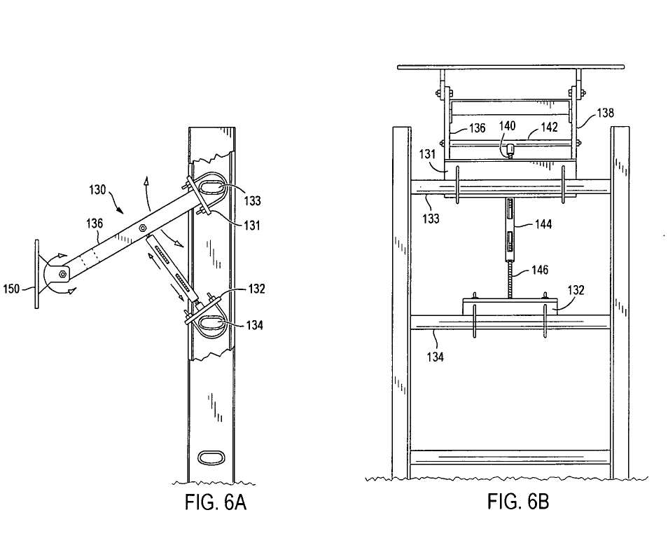

Turning now to FIGS. 6A and 6B, frame 130 comprises a first horizontal member 131 for pivotably attaching to an upper ladder rung 133, and a second horizontal member 132 for pivotably attaching to a lower ladder rung 134. Extension arms 136, 138 are attached to the first horizontal member 131. A first threaded rod 140 is secured to a pivot rod 142 attached to the extension arms and a second threaded rod 146 is secured to the second horizontal member 132. The first and second threaded rods 142 and 146 are connected by a turnbarrel 144, such that the extension arms can be locked at any one of a plurality of angles by turning the turnbarrel to change a distance between ends of the first and second threaded rods. Plate 150 is similar to plate 40 described above and is attached to the extension arms in a similar fashion.

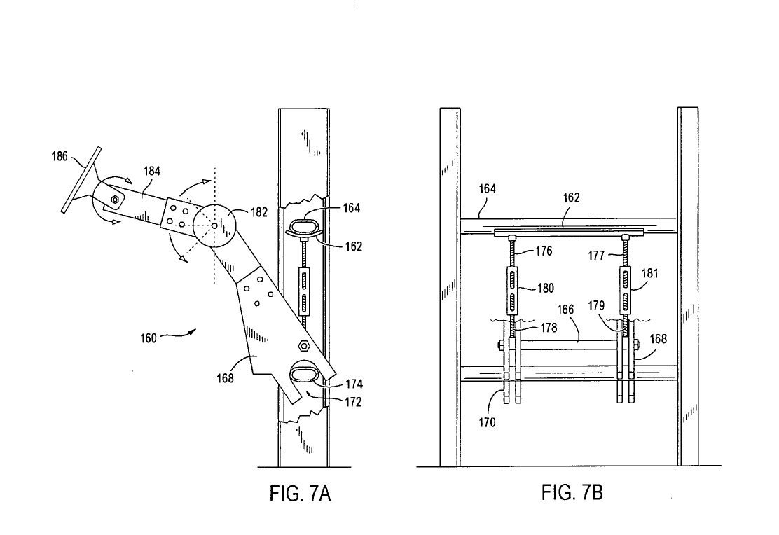

Turning now to FIGS. 7A and 7B, frame 160 comprises a first horizontal member 162 for contact with a lower surface of an upper ladder rung 164. A second horizontal member 166 is connected between a pair of risers 168, 170, each riser having a slot 172 for receiving a lower ladder rung 174. The first horizontal member 162 is attached to a first pair of threaded rods 176, 177. The second horizontal member 166 is attached to a second pair of threaded rods 178, 179. The first pair of threaded rods 176, 177 is connected to the second pair of threaded rods 178, 179 by a pair of turnbarrels 180, 181. The risers 168, 170 are each connected to one end of an articulated lockable hinge 182, and extension arms 184 are attached to an opposite end of the lockable hinge. Plate 186 is similar to plate 40 described above and is attached to the extension arms in a similar fashion. This type of frame is referred to as a “wedge mount” because the threaded rods and turnbarrels can be tightened to wedge the frame between the rungs 164 and 174 to hold it in place. FIG. 7B omits showing the plate, extension arms, hinge, and upper portions of the risers, to avoid clutter.

All of the frame embodiments described herein can be said to generally comprise an apparatus for mounting on an upper portion of a ladder to stabilize the ladder by facilitating a transfer of weight from the ladder to a horizontal or pitched surface in contact with the apparatus. Each apparatus comprises a frame comprising a pair of connecting members for attaching to the upper portion of the ladder, a pair of extension arms secured to the frame and having a distance between them that is less than or equal to a distance between the stiles of the ladder, and a plate pivotably attached to both of the extension arms and having a flat surface. In each embodiment, the extension arms have means for locking the arms in any one of a plurality of angles relative to a plane defined by the ladder.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. An apparatus for mounting on an upper portion of a ladder to stabilize the ladder by facilitating a transfer of weight from the ladder to a horizontal or pitched surface in contact with the apparatus, the apparatus comprising:
a frame having at least two vertical members and two horizontal members attached to the vertical members, each horizontal member comprising a ledge for receiving a lower surface of a ladder rung;
one or more securing members for securing the ladder rungs to the horizontal members;
a pair of extension arms, each pivotably connected to one of the vertical members and securable at one or more angles relative to the vertical member; and
a flat plate for contacting the horizontal or pitched surface, the plate pivotably attached to the pair of extension arms.

2. The apparatus of claim 1, wherein the horizontal members each have an L-shaped cross-section.

3. The apparatus of claim 1, wherein the extension arms are securable in a plurality of angles relative to the vertical member.

4. The apparatus of claim 3, wherein the vertical members each comprise a portion having a plurality of apertures arranged in an arc, each aperture for receiving a member to secure the extension arm at a desired angle corresponding to the aperture.

5. The apparatus of claim 1, further comprising means for pivotably attaching the plate to the pair of extension arms, the means comprising a mechanism for increasing or decreasing resistance to an applied pivot force.

6. The apparatus of claim 5, wherein the means for pivotably attaching comprises a tightening means having a T-shaped handle.

7. The apparatus of claim 1, wherein the securing members comprise U-bolts.

8. The apparatus of claim 1, further comprising one or more members sized to be removably attached to the flat plate for providing stabilization for a use of the ladder other than with the flat plate in contact with a horizontal or pitched surface.

9. The apparatus of claim 8, wherein the removably attachable member comprises a member for facilitating leaning the ladder against a tree.

10. The apparatus of claim 8, wherein the removably attachable member comprises a member for spanning a window when the ladder is leaned against a building.

11. The apparatus of claim 8, further comprising apertures in the flat plate for receiving the one or more removable attachable members.

12. The apparatus of claim 1, further comprising means for securing the flat plate to the roof.

13. The apparatus of claim 12 wherein the means comprise apertures that can also be used for attaching attachments to the flat plate.

14. The apparatus of claim 1, wherein the apparatus is adapted to attach to a ladder having stiles spaced a first distance apart from one another and the vertical members of the apparatus are spaced apart a second distance shorter than the first distance.

15. An apparatus for mounting on an upper portion of a ladder to stabilize the ladder by facilitating a transfer of weight from the ladder to a horizontal or pitched surface in contact with the apparatus, the ladder having stiles spaced a first distance apart from one another, the apparatus comprising:
a frame comprising a pair of connecting members for attaching to the upper portion of the ladder;
a pair of extension arms, each extension arm securable to the frame and having means for locking the arms in any one of a plurality of angles relative to a plane defined by the ladder, the extension arms having a second distance between them that is less than or equal to the first distance; and
a plate having a flat surface, the plate pivotably attached to both of the extension arms.

16. The apparatus of claim 15, wherein the connecting members comprise a pair of vertical members for attaching to vertical stiles of the ladder and the extension arms are connected to the vertical members by a lockable hinge.

17. The apparatus of claim 15, wherein the connecting members comprise a pair of horizontal members attached to a pair of vertical members to form the frame, each horizontal member comprising a ledge for receiving a lower surface of a ladder rung, the extension arms pivotably connected to the vertical members, and the vertical members each comprising a portion having a plurality of apertures arranged in an arc for locking the extension arms at any one of the plurality of angles, the apparatus further comprising one or more securing members for securing the ladder rungs to the horizontal members.

18. The apparatus of claim 15, wherein the connecting members comprise a first horizontal member for securing to an upper rung and a diagonal brace member attached to the first horizontal member at one end and secured to a lower rung at the opposite end, wherein the extension arms are pivotably connected to the first horizontal member and the first horizontal member comprises a brace having a plurality of apertures in an arc for locking the extension arms at any one of the plurality of angles.

19. The apparatus of claim 15, wherein the frame comprises at least two vertical members and two horizontal members attached to the vertical members, the connecting members comprising the horizontal members, each horizontal member adapted to be secured to a lower surface of a ladder rung, the frame further comprising a pair of brace members each pivotably connected to the vertical members and each having a length with a plurality of apertures along the length, each aperture is positioned to be aligned with a mating aperture in each extension arm and pinned through the aligned apertures to lock the extension arms in any one of the plurality of angles

20. The apparatus of claim 15, wherein the frame comprises a first horizontal member for contact with a lower surface of an upper ladder rung, a second horizontal member for connection between a pair of risers, each riser having a slot for receiving a lower ladder rung, the first and second horizontal members each attached to a first and second pair of threaded rods, respectively, the first pair of threaded rods connected to the second pair of threaded rods by a pair of turnbarrels, the risers each connected to one end of a lockable hinge, and the extension arms attached to an opposite end of the lockable hinge.

21. The apparatus of claim 15, wherein the frame comprises a first horizontal member for pivotably attaching to an upper ladder rung, a second horizontal member for pivotably attaching to a lower ladder rung, the extension arms attached to the first horizontal member, a first threaded rod secured to a pivot rod attached to the extension arms and a second threaded rod secured to the second horizontal member, the first and second threaded rods connected by a turnbarrel, wherein the extension arms can be locked at any one of the plurality of angles by turning the turnbarrel to change a distance between ends of the first and second threaded rods.

22. The apparatus of claim 15, wherein the second distance between the extension arms is a fixed distance that is not adjustable.

23. A ladder comprising the apparatus of claim 1.

24. A ladder comprising the apparatus of claim 15.
